(19) United States
(12) Patent Application Publication
(10) Pub. No.: US 2025/0118769 A1
(43) Pub. Date: Apr. 10, 2025

(54) ALKALINE DRY CELL

(71) Applicant: Panasonic Intellectual Property Management Co., Ltd., Osaka (JP)

(72) Inventors: JUN NUNOME, Kyoto (JP); SATOSHI FUJIYOSHI, Osaka (JP)

(21) Appl. No.: 18/836,340

(22) PCT Filed: Dec. 23, 2022
(86) PCT No.: PCT/JP2022/047540

§ 371 Date: Aug. 6, 2024

(30) Foreign Application Priority Data
Feb. 21, 2022 (JP) 2022-024605

(51) Int. Cl. H01M 6/06; H01M 4/02; H01M 4/06; H01M 4/38; H01M 4/50; H01M 50/489

(52) U.S. Cl. CPC H01M 6/06; H01M 4/06; H01M 4/38; H01M 4/50; H01M 50/489; H01M 2004/021; H01M 2300/0014

(57) ABSTRACT

An alkaline dry cell includes a cathode, an anode, a separator disposed between the cathode and anode, and an electrolyte held within the cathode, anode, and separator. The cathode includes manganese dioxide. A width at half maximum W of a (110)-plane diffraction peak in an X-ray diffraction pattern of the manganese dioxide is 2.4° or less. The anode includes powder of an anode active material including zinc. Particles s of the powder with particle diameters 75 μm or less account for 33% by mass or more of all particles of the powder. A thickness of the separator is 150 μm or more and is 210 μm or less.

### TECHNICAL FIELD

The present disclosure relates to an alkaline dry cell.

### BACKGROUND ART

An alkaline dry cell (alkaline manganese dry cell) has a larger capacity and allows for extraction of more current than a manganese dry cell, making it widely used. Improvements in cell components have been explored to improve performance of the alkaline dry cell.

An alkaline dry cell proposed in PTL 1 includes an anode including zinc powder, an electrolyte, a separator, and a cathode. The zinc powder includes 60 to 80% by weight of first zinc particles with particle diameters of 75 μm or more and 425 μm or less, and 40 to 20% by weight of second zinc particles with particle diameters of 75 μm or less.

A separator for alkaline dry cells proposed in PTL 2 includes a base material obtained by bonding 5.0 to 45.0 g/m² of a highly absorbent macromolecular compound of a cross-linking type having a carboxyl group to a wet-laid nonwoven including an alkali-resistant fiber, followed by cross-linking and a wet-laid nonwoven including an alkali-resistant fiber affixed to the cross-linked base material. The highly absorbent macromolecular compound of the crosslinking type includes a silicate compound added in an amount of 1.0×10⁻⁴ to 10 mg/cm² per separator unit area.

### CITATION LIST

### Patent Literatures

PTL 1: Japanese Patent Laid-Open Publication No. 2003-151539
PTL 2: Japanese Patent Laid-Open Publication No. 2007-227067

### SUMMARY OF INVENTION

Reducing thickness of a separator to improve the performance of the alkaline cell may lead to an internal short circuit during a discharge interruption.

An alkaline dry cell according to an aspect of the present disclosure includes a cathode, an anode, a separator disposed between the cathode and anode, and an electrolyte held within the cathode, anode, and separator. The cathode includes a manganese dioxide. A width at half maximum W of a (110)-plane diffraction peak in an X-ray diffraction pattern of the manganese dioxide is 2.4° or less. The anode includes powder of an anode active material including zinc. Particles of the powder with particle diameters 75 μm or less account for 33% by mass or more of all particles of the powder. A thickness of the separator is 150 μm or more and is 210 μm or less.

The alkaline dry cell according to the present disclosure prevents an internal short circuit during a discharge interruption.

### BRIEF DESCRIPTION OF THE DRAWING

FIG. 1 is a front view of an alkaline dry cell according to an exemplary embodiment of the present disclosure that is partly illustrated in section.

### DESCRIPTION OF EMBODIMENT

An alkaline dry cell includes a cathode, an anode, a separator disposed between the cathode and anode, and an electrolyte held within the cathode, anode, and separator. The cathode includes a manganese dioxide as a cathode active material. The anode includes an anode active material including zinc. Portions of the electrolyte held within the cathode, the anode, and the separator are referred to as “an in-cathode electrolyte,” “an in-anode electrolyte,” and “an in-separator electrolyte,” respectively.

Reducing thickness of the separator increases filling of the active materials and reduces internal resistance. However, an internal short circuit may occur during a discharge interruption, resulting in reduced discharge time. Inventors have investigated the above internal short circuit and obtained insights below.

As the cell discharges (as discharged electricity increases), the cathode expands and becomes more porous. The expanding cathode compresses the separator, and causes a portion of the in-separator electrolyte to move to the cathode, resulting in a decrease in the amount of in-separator electrolyte. Furthermore, as the discharge progresses to a certain extent, the in-separator electrolyte has a pH lowered. In a case where the separator is thin, the amount of the in-separator electrolyte decreases readily during discharge, and the pH of the in-separator electrolyte is lowered readily.

The lowering of the pH of the in-separator electrolyte may be caused due to a particular reaction of manganese dioxide that occurs in association with the decrease in the amount of the in-separator electrolyte. The reaction of the manganese dioxide which appears to be contrary to generally expected will be described below.

Manganese dioxide included in the cathode has a neutralizing effect by releasing more protons upon contacting a basic solution that is closer to neutral in pH. Conversely, the proton released from the manganese dioxide is less when the solution is a strong base with a lower proton concentration. Therefore, when the separator contacting the cathode holds a large amount of strongly basic electrolyte, the in-separator electrolyte hardly has a pH lowered. On the other hand, as the amount of the in-separator electrolyte decreases with the progress of the cell discharge, even a slight proton released from the manganese dioxide tends to increase the proton concentration of the in-separator electrolyte. Therefore, as the in-separator electrolyte decreases, the proton released from the manganese dioxide increases drastically, facilitating the lowering of the pH of the in-separator electrolyte. Surprisingly, the pH can drop to about 9.

At the anode, zinc ions are generated during discharge, leading to an increased zinc ion concentration in the in-anode electrolyte. During the discharge interruption, the cathode stops expanding, and accordingly, a portion of the in-anode electrolyte with the increased zinc ion concentration slowly moves little by little to the separator holding the electrolyte with the lowered pH, resulting in diffusion of many zinc ions in the in-separator electrolyte. In the meantime, since zinc ion solubility is excessively small in aqueous solutions with a neutral pH range of, for example, from 9 to 10 than in higher-pH aqueous solutions. Innumerable microcrystals of conductive zinc oxide are facilitated in gaps between fibers of the separator during the discharge interruption, serving as P-type semiconductors to cause the internal short circuit. When the separator is thin, not only microcrystals are facilitated within the separator where the pH of the in-separator electrolyte is lowered to around neutrality due to the easily decreased in-separator electrolyte, but also a shorter distance between the cathode and anode makes the internal short circuit more likely to occur. The electrolyte before discharge is typically strongly alkaline, having a pH of about 15, in which case about 5% by mass of zinc in terms of zinc oxide can dissolve in the electrolyte.

The smaller the width at half maximum of a (110)-plane diffraction peak in an X-ray diffraction pattern of manganese dioxide, the more likely the expansion rate of the cathode (manganese dioxide) decreases, leading to restrained movement of the in-separator electrolyte toward the cathode during discharge.

The larger the proportion of fine particles (with particle diameters of 75 μm or less) among anode active material particles included in the anode, the larger the surface area of the anode active material included in the anode, and the more likely the anode's capacity to hold the electrolyte increases, resulting in restrained movement of the in-anode electrolyte toward the separator during the interruption.

While the amount of added gelling agent and molecular weight of the added gelling agent also affect the anode's capacity to hold the electrolyte, surface tension of the anode active material is conceivably more influential on the movement of the in-anode electrolyte toward the separator during the discharge interruption than the amount of added gelling agent and the other. The amount of added gelling agent, among others, may affect the movement of the electrolyte among the anode, separator, and cathode from immediately after cell production until the start of use, that is, during a storage period.

On the basis of the above insights, inventors have conducted a diligent study, focusing on above-mentioned width at half maximum W and the proportion of the above-mentioned fine particles. As a result, the inventors have found that, in the case that the separator has a small thickness of 210 μm or less, width at half maximum W and the proportion of the fine particles within respective particular ranges prevent the internal short circuit during the discharge interruption.

In other words, an alkaline dry cell according to an exemplary embodiment of the present disclosure includes a cathode, an anode, a separator disposed between the cathode and the anode, and an electrolyte held within the cathode, anode, and separator. The cathode includes a manganese dioxide. A width at half maximum W of a (110)-plane diffraction peak in an X-ray diffraction pattern of the manganese dioxide is 2.4° or less. The anode includes powder of an anode active material including zinc. Particles of the powder with particle diameters 75 μm or less account for 33% by mass or more of all particles of the powder. A thickness of the separator is 150 μm or more and is 210 μm or less.

In a case that width at half maximum W is 2.4° or less and the proportion of the fine particles is 33% by mass or more, the separator with thickness T of 210 μm or less increases capacity, reduces internal resistance, and prevents an internal short circuit during a discharge interruption. However, the separator with thickness T less than 150 μm decreases a distance between the cathode and anode and decreases mechanical strength of the separator and is damaged when, for example, the cell is dropped, leading to an internal short circuit.

### Cathode

The cathode includes the manganese dioxide as a cathode active material. The cathode active material to be used is typically electrolytic manganese dioxide, and the electrolytic manganese oxide has, for example, a y-phase crystal structure.

Width at half maximum W of the (110)-plane diffraction peak in the X-ray diffraction pattern of the manganese dioxide is 2.4° or less, preferably is 1.8° or more and 2.4° or less, and more preferably is ranges 1.9° or more and 2.3° or less. Width at half maximum W of 1.8° or more reduces a decrease in diffusion rate of hydrogen ions in manganese dioxide crystals and an associated decrease in heavy-load discharge performance.

In a case that width at half maximum W is small, crystallite size is large, and a rate of expansion of crystal grains that is caused by entry of hydrogen atoms during discharge into a crystal lattice where Mn and O atoms are arranged at specific sites is low. Therefore, the expansion of the cathode during discharge is restrained.

The above-mentioned “(110)-plane diffraction peak” is seen around diffraction angle 2θ=22±1° and is a diffraction peak attributed to a (110)-plane when the manganese dioxide is assumed to have a ramsdellite structure. Above-mentioned “width at half maximum W” refers to a full width at half maximum (FWHM).

Width at half maximum W may be determined by the following method.

An unused (yet-to-discharge) cell is disassembled, and the cathode is extracted, cleansed with water, dried, and then ground into a powder sample. X-ray powder diffraction measurement using CuKα radiation is performed on the obtained powder sample. Width at half maximum W of the (110)-plane diffraction peak is determined using an X-ray diffraction pattern (where a vertical axis represents X-ray diffraction intensity, while a horizontal axis represents diffraction angle 2θ) obtained by the above measurement.

### Anode

The anode includes zinc or a zinc alloy as the anode active material. From the perspective of corrosion resistance, the zinc alloy preferably includes at least one selected from the group consisting of indium, bismuth, and aluminum. The zinc alloy preferably includes 100 ppm or more and 280 ppm or less of indium, 60 ppm or more and 200 ppm or less of bismuth, and 10 ppm or more and 80 ppm or less of aluminum.

The anode active material is typically used in powder form. From the perspectives of fillability of the anode and diffusion of the alkaline electrolyte in the anode, an average particle diameter of all the particles of the power of the anode active material is, for example, 80 μm or more and 200 μm or less, preferably is 100 μm or more and 150 μm or less.

The average particle diameter herein refers to a median diameter (D50) in a volume-based particle diameter distribution. The average particle diameter may be determined, for example, using a laser diffraction and/or scattering particle diameter distribution measurement device.

The fine particles account for 33% by mass or more, preferably for 33% by mass or more and 55% by mass or less, more preferably for 36% by mass or less and 46% by mass or more of all the particles of the powder of the anode active material included in the anode. The proportion of the fine particles of 55% by mass or less provides moderately high reactivity, reduces an increase in cell temperature during an external short circuit, and enhances safety.

The fine particles are particles with particle diameters of 75 μm or less that pass through a (200-mesh) sieve with 75-μm openings. The larger the proportion of the fine particles among all the particles of the powder included in the anode active material, the more the area of contact between the anode active material and the electrolyte increases, facilitating discharge reaction and improving the anode's electrolyte retention.

The proportion of the fine particles among all the particles of the powder of the anode active material included in the anode may be determined as follows.

The anode is extracted from an unused (yet-to-discharge) cell that has been disassembled, and weight W0 of the powder of the anode active material is extracted from the anode and is measured. After that, using the sieve, the fine particles (with the particle diameters of 75 μm or less) are separated from the powder of the anode active material, and weight W1 of the fine particles is measured. The proportion of the fine particles is calculated as W1/W0×100.

The above extraction of the anode active material in powder form from the anode is carried out as follows. First, an adequate amount of distilled water is added to the anode and stirred to cleanse the anode active material. Specifically, the anode active material is precipitated in the distilled water, and a supernatant liquid including components (such as a gelling agent and the electrolyte) other than the anode active material is removed. This work is repeated several times. Furthermore, the anode active material is cleansed with anhydrous ethanol to remove a slight amount of moisture on the anode active material and then dried at 100° C. for a short time. This prevents surface oxidation of the anode active material.

### Separator

The separator may be preferably made of a nonwoven fabric. For example, a nonwoven sheet including cellulose fibers and polyvinyl alcohol fibers is used for the separator. The nonwoven sheet, which mainly contains the cellulose fibers and the polyvinyl alcohol fibers may be obtained by, for example, mixing these fibers. The cellulose fibers are, for example, rayon fibers (regenerated fibers). The content of the nonwoven sheet contains a polyvinyl alcohol fiber is, for example, 25 parts by mass or more and 150 parts by mass or less per 100 parts by mass of the cellulose fibers.

Thickness T of the separator is 150 μm or more and 210 μm or less, and is preferably 170 μm or more and 200 μm or less. Thickness T of the separator refers to a thickness of the separator soaked with the electrolyte in the cell, corresponding to a distance between the cathode and the anode inside the cell.

The separator to be disposed between the cathode and the anode has typically a cylindrical shape. The cylindrical separator may be constructed by rolling a sheet of base material with thickness t (μm) to have an X-layer cylindrical shape. Alternatively, X sheets of base material each with thickness t (μm) may be stacked together and rolled to have a single-layer cylindrical shape. When above thickness t is the thickness of the sheet of base material soaked with the electrolyte in the cell, thickness T is obtained as t×X. When the separator has an overlap P1 where one starting end of the rolled sheet of base material overlaps with an opposite terminal end of the rolled sheet of base material, thickness T of the separator refers to a thickness of a portion other than the overlap P1.

Thickness T of the separator may be determined as follows.

An X-ray computed tomography (CT) image of a cross section of a power generation element (that includes the cathode, the anode, and the separator, with the electrolyte held within them) accommodated in an unused (yet-to-discharge) cell is obtained by CT scanning. Respective distances between ten arbitrary points of the cathode and ten arbitrary points of the anode on the separator accommodated in the cell is sandwiched are measured (except for the overlap P1, if present), using the cross-sectional image. An average of the measured thicknesses is calculated as thickness T.

The separator may have a density of 0.22 g/cm³ or more and 0.29 g/cm³ or less. In this case, sufficient mechanical strength is ensured, preventing the separator from being damaged, for example, during a cell manufacturing process or when the cell is dropped, and allowing for satisfactory isolation between the cathode and the anode despite the small thickness. The density of the separator may be determined by dividing the weight of the separator by the volume of the separator. The weight of the separator refers to the weight of the separator in a dry state where the electrolyte is not included. The weight of the separator may be determined by removing the separator from the cell, cleansing the separator with water to remove the electrolyte, drying the separator, and then measuring the weight. The volume of the separator may be determined on the basis of an area of the separator and above thickness T. The area of the separator may be determined by removing the separator from the cell and measuring lengthwise and crosswise dimensions of the separator.

The electrolyte to be used is, for example, a potassium hydroxide solution. The electrolyte has a potassium hydroxide content of, for example, 30% by mass or more and 50% by mass or less. The electrolyte may further include zinc oxide. The electrolyte has a zinc oxide content is, for example, 1% by mass or more and 5% by mass or less. The potassium hydroxide content (% by mass) and the zinc oxide content (% by mass) of the electrolyte refer respectively to a ratio (percent) of the mass of potassium hydroxide included in the electrolyte to total mass of the electrolyte and a ratio (in percent) of the mass of zinc oxide included in the electrolyte to the total mass of the electrolyte.

With reference to the drawing, a detailed description is hereinafter provided of an alkaline dry cell according to the present exemplary embodiment. It is to be noted that the exemplary embodiment described below is not restrictive of the present disclosure. Any modifications are possible as appropriate without departing from the scope that produces the effect of the present disclosure, and combinations with other exemplary embodiments are also possible.

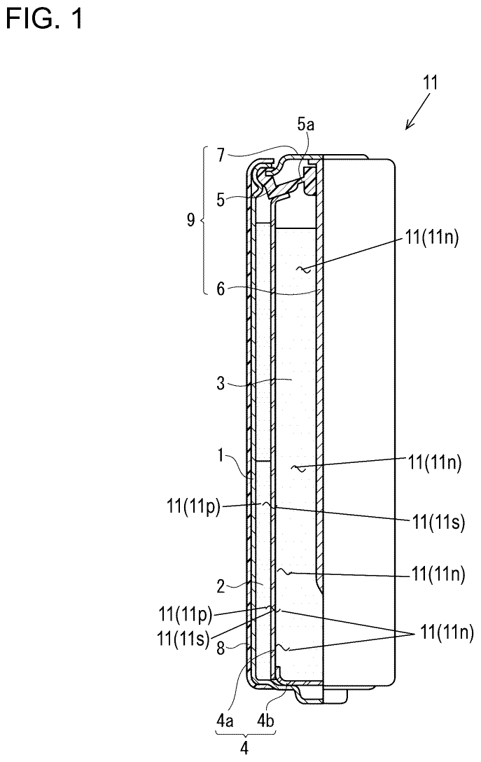

FIG. 1 is a front view of alkaline dry cell 10 according to the exemplary embodiment of the present disclosure, illustrating one half side in section.

As illustrated in FIG. 1, alkaline dry cell 10 includes a power generation element that includes cathode 2 having a hollow cylindrical shape, gelled anode 3 disposed in the hollow of cathode 2, separator 4 disposed between cathode 2 and anode 3, and electrolyte 11 which is an alkaline electrolyte. The power generation element is accommodated in metal case 1 having a cylindrical shape with a bottom, which also serves as a positive electrode terminal. Case 1 may be made of, for example, a nickel-plated steel plate. Cathode 2 contacts an inner wall of case 1. Case 1 preferably has an inner surface covered with a carbon coating for enhanced adherence between cathode 2 and case 1.

Separator 4 having a cylindrical shape with a bottom is composed of separator 4a with a cylindrical shape and bottom 4b. Separator 4a is disposed along an inner surface of cathode 2 that defines the hollow, separating cathode 2 away from anode 3. Separator 4a with a cylindrical shape refers to a separator disposed between the cathode and the anode and has a thickness of 150 μm or more and 210 μm or less. Bottom 4b is disposed at the bottom of the hollow of cathode 2, separating anode 3 away from case 1.

At least cathode 2, anode 3, and separator 4 are permeated by electrolyte 11; therefore, electrolyte 11 includes at least in-cathode electrolyte 11p, in-anode electrolyte 11n, and in-separator electrolyte 11s that are held within cathode 2, anode 3, and separator 4, respectively.

Case 1 has an opening sealed with sealing unit 9. Sealing unit 9 includes gasket 5 made of resin, negative terminal plate 7 that also serves as a negative electrode terminal, and anode current collector 6. Gasket 5 includes annular thin-wall part 5a where gasket 5 is locally thin. When internal pressure of the cell exceeds a predetermined value, thin-wall part 5a breaks, discharging gas out of the cell. Anode current collector 6 is inserted in anode 3. Anode current collector 6 is made of, for example, an alloy material, such as brass that includes copper and zinc. If necessary, anode current collector 6 may be plated with, e.g., tin. Anode current collector 6 has a nail shape having a head and a shank. The shank is inserted through a through hole formed in a central tube of gasket 5, while the head of anode current collector 6 is welded to a central flat part of negative terminal plate 7. An open end of case 1 is crimped to a peripheral flange of negative terminal plate 7 via an outer peripheral end of gasket 5. Case 1 has an outer peripheral surface covered with exterior label 8.

Cathode 2 includes a manganese dioxide as a cathode active material and the electrolyte. Width at half maximum W of a (110)-plane diffraction peak in an X-ray diffraction pattern of the manganese dioxide included in cathode 2 is 2.4° or less.

The manganese dioxide is used in powder form in cathode fabrication. The manganese dioxide has an average particle diameter is, for example, 25 μm or more and 55 μm or less, and is preferably 32 μm or more and 50 μm or less. In this case, satisfactory cell performance is obtained easily. The particle diameter of the manganese dioxide may be adjusted, for example, by grinding and classification.

The cathode active material may include, in addition to the manganese dioxide, a different manganese oxide, a nickel oxide, or a different oxide. In this case, the manganese dioxide accounts for, for example, 50% by mass or more of the cathode active material or may account for 75% by mass or more of the cathode active material.

Cathode 2 may include a conductive agent in addition to the manganese dioxide and the electrolyte. Examples of the conductive agent include carbon black, such as acetylene black, and a conductive carbon material, such as graphite. Usable examples of the graphite include natural graphite and synthetic graphite. The conductive agent may be, for example, fibrous but is preferably in powder form. The conductive agent has an average particle diameter of, for example, 5 nm or more and 50 μm or less. The average particle diameter of the conductive agent is preferably 5 nm or more and 40 nm or less for the carbon black, and is 3 μm more and 50 μm or less for the graphite.

The cathode may have, for a total of 100 parts by mass of the manganese dioxide and the graphite, a graphite content of 3 parts by mass or more and 8 parts by mass or less, and is preferably 4 parts by mass or more and 7 parts by mass or less. In the case that the graphite content is 7% by mass or less, a sufficient amount of manganese dioxide to be filled is easily ensured, and satisfactory cell performance is easier to obtain.

Cathode 2 may be obtained by, for example, compressing and molding a cathode mixture including the cathode active material, the conductive agent, and the electrolyte into pellets. The cathode mixture may initially have flakes or granules, classified if necessary, and then compressed and molded into the pellets. After being placed in the case, the pellet(s) may undergo secondary pressing using a predetermined tool to adhere to the inner wall of the case. The cathode (cathode mixture) may further include other components (such as polytetrafluoroethylene) as needed.

The manganese dioxide of the cathode has a density of, for example, 2.70 g/cm³ or more and 3.10 g/cm^{3 or less}, and is preferably 2.80 g/cm³ or more and 3.05 g/cm^{3 or less} The density of the manganese dioxide of the cathode may be determined by dividing the weight of the manganese dioxide included in the cathode by the volume of the cathode. The weight of the manganese dioxide included in the cathode may be determined by removing the cathode from the cell, dissolving the cathode well in acid, removing insoluble matter to collect a solution, determining an Mn content of the solution by inductively coupled plasma optical emission spectroscopy (ICP optical emission spectrometry), and then converting the Mn content to an amount of MnO₂. The volume of the cathode may be determined on the basis of an outside diameter, an inside diameter, and a height of the cathode, measurements of which are obtained using X-ray CT images of the cell.

The cathode has a density of, for example, 2.85 g/cm³ or more and 3.30 g/cm³ or less, and is preferably 2.90 g/cm³ or more and 3.20 g/cm³ or less. The density of the cathode may be determined by dividing the weight of the cathode by the volume of the cathode. The weight of the cathode refers to the weight of the cathode holding in-cathode electrolyte 11p and may be determined by removing the cathode from the cell and measuring the weight. The volume of the cathode may be determined by the method mentioned above.

Anode 3 is gelled and includes an anode active material in powder form, the electrolyte, and a gelling agent. Fine particles (with particle diameters of 75 μm or less) account for 33% by mass or more of all particles of the powder of the anode active material included in anode 3.

The gelling agent to be used is not particularly limited and may include any known gelling agent used in the field of alkaline dry cells, such as a water-absorbent polymer. Examples of such a gelling agent include polyacrylic acid and sodium polyacrylate. The gelling agent may be added in an amount of 0.5 parts by mass or more and 2 parts by mass or more per 100 parts by mass of the anode active material.

For the separator, the above-exemplified nonwoven is preferably used, or a microporous membrane, such as cellophane, may be used as an example other than the nonwoven. For bottom 4b, the one exemplified for cylindrical separator 4a can be used.

While separator 4 having a cylindrical shape is composed of cylindrical separator 4a and bottom 4b shown in FIG. 1, this is not limited. An integral separator of a bottomed cylinder shape may be used, and any separator of a known shape used in the field of alkaline dry cells can be used.

### EXAMPLES

A concrete description of the present disclosure is provided below on the basis of Examples and Comparative Examples; however, the present disclosure is not limited to Examples below.

### Examples 1-35 and Comparative Examples 1-26

Each AA (LR6) cylindrical alkaline dry cell 10 illustrated in FIG. 1 was fabricated according to a procedure described below.

### Fabrication of Cathode

A mixture was obtained by adding 0.2 parts by mass of polytetrafluoroethylene to 94.3 parts by mass of a cathode active material and 5.7 parts by mass of graphite powder (with an average particle diameter of 8 μm) that total 100 parts by mass. After adding 2 parts by mass of an electrolyte to 100.2 parts by mass of the mixture and thoroughly stirring the mixture, the mixture was compressed and molded into flakes, thus forming a cathode mixture. The electrolyte used was a KOH solution (40% by mass concentration) that included 2% by mass of ZnO.

The cathode mixture having flake shapes was ground into granules, and a predetermined amount of granules obtained by classification using 10- to 100-mesh sieves was compressed and molded into pellets of hollow cylindrical shapes with outside diameters of 13.65 mm and heights of 21.7 mm. Two of these cathode pellets were accommodated in a cell case.

The cathode active material used was y-manganese dioxide in powder form (with an average particle diameter of 40 μm) synthesized by electrolysis. A current value was appropriately adjusted during the synthesis by electrolysis, resulting in each manganese dioxide having peak value W of a (110)-plane diffraction peak in an X-ray powder diffraction pattern using CuKα radiation, as shown in TABLES 1-3.

### Fabrication of Anode

A gelled anode was obtained by mixing 100 parts by mass of an anode active material, 49 parts by mass of an electrolyte, and 1 part by mass of a gelling agent together. The anode active material used was zinc alloy powder that included 0.02% by mass of indium, 0.01% by mass of bismuth, and 0.0045% by mass of aluminum. The gelling agent used was a mixture of cross-linked branched polyacrylic acid and highly cross-linked linear sodium polyacrylate. The electrolyte used was a KOH solution (of 33% by mass concentration) that included 2% by mass of ZnO.

For the zinc alloy powder, coarse powder with particle diameters of more than 75 μm and 500 μm or less and fine powder with particle diameters of 75 μm or less were obtained using sieves. Subsequently, a mixing ratio of the coarse to fine powders was appropriately adjusted, resulting in a fine powder content of each zinc alloy powder shown in TABLES 1-3. The zinc alloy powder had an average particle diameter of 100 μm or more and 150 μm or less.

### Assembling of Alkaline Dry Cell

The two cathode pellets were longitudinally inserted into case 1 and then pressed, thus forming cathode 2 adhered to an inner wall of case 1. Case 1 used had a cylindrical shape with a bottom (with an outside diameter of 14.0 mm and a height of 49.9 mm) made of a nickel-plated steel plate, with its inner surface covered with a carbon coating.

Separator 4 having a cylindrical shape with a bottom was disposed inside cathode 2, and a predetermined amount of electrolyte was put into case 1 and absorbed by separator 4. Separator 4 was constructed of separator 4a with a cylindrical shape and bottom 4b. For separator 4a with the cylindrical shape and bottom 4b, a nonwoven sheet mainly made of rayon fibers and polyvinyl alcohol fibers mixed in a mass ratio of 1:1 was used. Separator 4a with the cylindrical shape was formed by rolling the nonwoven sheets into two layers. Bottom 4b had a thickness of 140 μm. The electrolyte put into the case and having the separator impregnated with the electrolyte was the same as that used in the anode fabrication. The electrolyte was left in this state for a predetermined time to permeate separator 4 and then cathode 2. After that, a predetermined amount of gelled anode 3 filled separator 4.

Thicknesses of the nonwoven sheets was changes, resulting in thickness T of each separator 4a with the cylindrical shape as shown in TABLES 1-3. The amounts of cathode 2 and anode 3 to fill the cell were appropriately adjusted, depending on thickness T of separator 4a with the cylindrical shape. The amount of cathode 2 to fill was adjusted by changing an inside diameter of each cathode pellet. The cathode and anode filled the cell in a constant mass ratio. As thickness T decreased, the amount of cathode filling and the amount of anode filling increased.

Sealing unit 9 composed of gasket 5, negative terminal plate 7, and anode current collector 6 was installed to an opening of case 1. Anode current collector 6 had a shank inserted into anode 3. An open end of case 1 was crimped to a peripheral part of negative terminal plate 7 via gasket 5, thus closing the opening of case 1. Case 1 had an outer peripheral surface covered with exterior label 8, thus providing alkaline dry cell 10. In the tables, A1-A35 denote cells according to Examples 1-35, and B1-B26 denote cells according to Comparative Examples 1-26, respectively.

The manganese dioxide of cathode 2 had a density 2.93 or more and 2.96 g/cm³ or less. Cathode 2 had a density of 3.10 g/cm³. Separator 4a with the cylindrical shape had a density of 2.7 g/cm³.

Examples and Comparative Examples were evaluated as follows for their cells.

### Evaluation 1: Internal Short Circuit Rate During Discharge

A process of causing a constant current (250 mA) discharge for 1 hour in a 20±1° C. environment followed by a 23-hour interruption was repeated as intermittent discharge. In the meantime, discharge time was measured until a closed circuit voltage of each cell reached 0.9 V. The discharge time refers to a total discharge time of the discharge of 250 mA, excluding interruption time. When the discharge time was less than 8.5 hours, a determination was made that an internal short circuit had occurred during discharge. The intermittent discharge was performed for each of six cells, and the number out of these six cells which had internal short circuits during discharge was determined. TABLES 1-3 show evaluation results.

TABLE 1

| | Width at half | | | |
|---|---|---|---|---|
| | maximum W (°) | | | Number of |
| | of (110)-Plane | Proportion (% | | Internal Short |
| | Diffraction | by mass) of | | Circuits |
| | Peak in XRD | Fine Particles | Separator | Occurred/ |
| | Pattern of | in Zinc | Thickness | Number of |
| | Manganese Dioxide | Alloy Powder | T (μm) | Cells Tested |
| B1 | 2.60 | 30 | 170 | 4/6 |
| B2 | 2.39 | 30 | 170 | 1/6 |
| B3 | 2.18 | 30 | 170 | 1/6 |
| B4 | 2.05 | 30 | 170 | 1/6 |
| B5 | 1.91 | 30 | 170 | 1/6 |
| B6 | 2.60 | 30 | 190 | 3/6 |
| B7 | 2.39 | 30 | 190 | 1/6 |
| B8 | 2.18 | 30 | 190 | 1/6 |
| B9 | 2.05 | 30 | 190 | 1/6 |
| B10 | 1.91 | 30 | 190 | 1/6 |
| B11 | 2.60 | 30 | 200 | 2/6 |
| B12 | 2.39 | 30 | 200 | 1/6 |
| B13 | 2.18 | 30 | 200 | 1/6 |
| B14 | 2.05 | 30 | 200 | 1/6 |
| B15 | 1.91 | 30 | 200 | 1/6 |
| B16 | 2.60 | 30 | 210 | 1/6 |
| B17 | 2.60 | 30 | 230 | 0/6 |

TABLE 2

| | Width at half | | | |
|---|---|---|---|---|
| | maximum W (°) | | | Number of |
| | of (110)-Plane | Proportion (% | | Internal Short |
| | Diffraction | by mass) of | | Circuits |
| | Peak in XRD | Fine Particles | Separator | Occurred/ |
| | Pattern of | in Zinc | Thickness | Number of |
| | Manganese Dioxide | Alloy Powder | T (μm) | Cells Tested |
| B18 | 2.60 | 33 | 150 | 2/6 |
| A1 | 2.39 | 33 | 150 | 0/6 |
| A2 | 2.18 | 33 | 150 | 0/6 |
| A3 | 2.05 | 33 | 150 | 0/6 |
| A4 | 1.91 | 33 | 150 | 0/6 |
| A5 | 1.80 | 33 | 150 | 0/6 |
| B19 | 2.60 | 33 | 170 | 2/6 |
| A6 | 2.39 | 33 | 170 | 0/6 |
| A7 | 2.18 | 33 | 170 | 0/6 |
| A8 | 2.05 | 33 | 170 | 0/6 |
| A9 | 1.91 | 33 | 170 | 0/6 |
| A10 | 1.80 | 33 | 170 | 0/6 |
| B20 | 2.60 | 33 | 190 | 1/6 |
| A11 | 2.39 | 33 | 190 | 0/6 |
| A12 | 2.18 | 33 | 190 | 0/6 |
| A13 | 2.05 | 33 | 190 | 0/6 |
| A14 | 1.91 | 33 | 190 | 0/6 |
| A15 | 1.80 | 33 | 190 | 0/6 |
| B21 | 2.60 | 33 | 200 | 1/6 |
| A16 | 2.39 | 33 | 200 | 0/6 |
| A17 | 2.18 | 33 | 200 | 0/6 |
| A18 | 2.05 | 33 | 200 | 0/6 |
| A19 | 1.91 | 33 | 200 | 0/6 |
| A20 | 1.80 | 33 | 200 | 0/6 |
| B22 | 2.60 | 33 | 210 | 1/6 |
| A21 | 2.39 | 33 | 210 | 0/6 |

TABLE 3

| | Width at half | | | |
|---|---|---|---|---|
| | maximum W (°) | | | Number of |
| | of (110)-Plane | Proportion (% | | Internal Short |
| | Diffraction | by mass) of | | Circuits |
| | Peak in XRD | Fine Particles | Separator | Occurred/ |
| | Pattern of | in Zinc | Thickness | Number of |
| | Manganese Dioxide | Alloy Powder | T (μm) | Cells Tested |
| B23 | 2.60 | 40 | 170 | 2/6 |
| A22 | 2.39 | 40 | 170 | 0/6 |
| A23 | 2.18 | 40 | 170 | 0/6 |
| A24 | 2.05 | 40 | 170 | 0/6 |
| A25 | 1.91 | 40 | 170 | 0/6 |
| B24 | 2.60 | 40 | 190 | 2/6 |
| A26 | 2.39 | 40 | 190 | 0/6 |
| A27 | 2.18 | 40 | 190 | 0/6 |
| A28 | 2.05 | 40 | 190 | 0/6 |
| A29 | 1.91 | 40 | 190 | 0/6 |
| B25 | 2.60 | 40 | 200 | 1/6 |
| A30 | 2.39 | 40 | 200 | 0/6 |
| A31 | 2.18 | 40 | 200 | 0/6 |
| A32 | 2.05 | 40 | 200 | 0/6 |
| A33 | 1.91 | 40 | 200 | 0/6 |
| B26 | 2.60 | 40 | 210 | 1/6 |
| A34 | 2.39 | 55 | 150 | 0/6 |
| A35 | 1.80 | 55 | 150 | 0/6 |

Cells with internal short circuits were not observed for cells A1-A35 which had the separator with the thickness of 210 μm or less and the width at half maximum W of 2.4° or less, the fine particles accounting for 33% by mass or more of all particles in the zinc alloy powder. Cells A1-A35 which had the separator with the thickness of 210 μm or less increased in filling of the cathode and the anode.

In cells B1-B16 and B18-B26 with the separator with the thickness of 210 μm or less and the width at half maximum W of more than 2.4° and/or the fine particles accounting for less than 33% by mass of all particles in the zinc alloy powder, cells with internal short circuits were observed.

While cell B17 had no internal short circuit, the separator with the thickness more than 210 μm led decreased filling of the cathode and the anode.

### INDUSTRIAL APPLICABILITY

An alkaline dry cell according to the present disclosure is suitable for use as a power supply for, e.g., portable audio equipment, electronic games, and lights, among others.

### REFERENCE MARKS IN THE DRAWINGS

1 case
2 cathode
3 anode
4 separator
4a separator with cylindrical snape
4b bottom
5 gasket
5a thin-wall part
6 anode current collector
7 negative terminal plate
8 exterior label
9 sealing unit

1. An alkaline dry cell comprising:
a cathode;
an anode;
a separator disposed between the cathode and the anode; and
an electrolyte held within the cathode, the anode, and the separator, wherein
the cathode includes a manganese dioxide,
a width at half maximum W of a (110)-plane diffraction peak in an X-ray diffraction pattern of the manganese dioxide is 2.4° or less,
the anode includes powder of an anode active material including zinc,
particles of the powder with particle diameters 75 μm or less account for 33% by mass or more of all particles of the powder, and
a thickness of the separator is 150 μm or more and is 210 μm or less.

2. The alkaline dry cell according to claim 1, wherein the width at half maximum W ranges is 1.8° or more and is 2.4° or less.

3. The alkaline dry cell according to claim 1, wherein
the particles less than or equal to 75 μm in particle diameter account for 33% by mass or more of the all particles of the powder and for 55% by mass or less of the all particles of the powder.

4. The alkaline dry cell according to claim 1, wherein a thickness of the separator is 170 μm or more and is 200 μm or less.
